(19) United States
(12) Patent Application Publication
(10) Pub. No.: US 2026/0166494 A1
(43) Pub. Date: Jun. 18, 2026

(54) Gas Separation System and Method for Managing the Same

(71) Applicants: Hyundai Motor Company, Seoul (KR); Kia Corporation, Seoul (KR)

(72) Inventor: Woo Ram Kang, Hwaseong-Si (KR)

(21) Appl. No.: 19/254,955

(22) Filed: Jun. 30, 2025

(30) Foreign Application Priority Data
Dec. 18, 2024 (KR) 10-2024-0189471

(51) Int. Cl. B01D 65/10; B01D 63/06

(52) U.S. Cl. CPC B01D 65/10; B01D 63/069; B01D 2311/16; B01D 2313/60; B01D 2313/701

(57) ABSTRACT

An apparatus of a gas system may comprise a processor and a memory storing at least one instruction that, when executed by the processor communicating with the memory, is configured to cause the apparatus to separate a target gas from a gas mixture using a plurality of gas separation membranes of the gas system, obtain, via a first sensor connected with a first pipe, first sensing data corresponding to a reference exhaust gas discharged from a reference gas separation membrane, obtain, via a second sensor connected with a second pipe, second sensing data corresponding to a total exhaust gas discharged from the plurality of gas separation membranes, output a signal indicating whether at least one membrane is defective, and control a flow path based on the signal.

### CROSS-REFERENCE TO RELATED APPLICATION

This application claims the benefit of priority to Korean Patent Application No. 10-2024-0189471, filed in the Korean Intellectual Property Office on Dec. 18, 2024, the entire contents of which are incorporated herein by reference.

### TECHNICAL FIELD

The present disclosure relates to a gas separation system and a method for managing the same, and more particularly, relates to a technology for determining an abnormal state of a gas separation system.

### BACKGROUND

The matters described in this Background section are only for enhancement of understanding of the background of the disclosure, and should not be taken as acknowledgment that they correspond to prior art already known to those skilled in the art.

Gas separation technology refers to a technology for separating a specific gas from a mixture gas in which two or more gases are mixed. For example, the gas separation technology may be used to trap carbon dioxide (CO₂) generated in a chemical process. In order to solve the problems of global warming and abnormal climate caused by greenhouse gas emissions, the demand for carbon neutrality is increasing, and accordingly the gas separation technology is increasingly used.

The gas separation technology may be implemented in various ways, and among them, a technology for separating a gas using a separator may be used. A gas separation system using a separator includes a plurality of separators, and each of the separators may perform a gas separation process.

Because the performance of the separators deteriorates with age, the separators need to be replaced when the desired performance may not be expected. The aging of the separators may not be constant, and therefore unnecessary costs may be required to replace the plurality of separators at once. Accordingly, it is desirable to monitor the performance of the separators and replace separators exhibiting poor performance.

A method of examining the exhaust gas of the separators may be used to determine the performance of the separators. In order to examine the performance of one target separator among the plurality of separators, a method of closing the discharge paths of separators other than the target separator and examining the exhaust gas of the target separator may be used. Analysis of the components of the exhaust gas may be performed as many times as the number of separators to examine the performance of all of the separators in this way, and therefore it may take a lot of working time.

In order to reduce the time required to examine the performance of the plurality of separators, a monitoring system for examining performance may be installed for each separator. Multiple monitoring systems may cost a lot of money.

Accordingly, a separator management method capable of saving costs while reducing working time is considered.

### SUMMARY

The present disclosure has been made to solve the above-mentioned problems.

According to the present disclosure, an apparatus of a gas system, the apparatus may comprise a processor, and a memory storing at least one instruction that, when executed by the processor communicating with the memory, is configured to cause the apparatus to separate a target gas from a gas mixture using a plurality of gas separation membranes of the gas system, obtain, via a first sensor of the gas system connected with a first pipe of the gas system, first sensing data corresponding to a reference exhaust gas discharged from a reference gas separation membrane selected from the plurality of gas separation membranes, obtain, via a second sensor of the gas system connected with a second pipe of the gas system, second sensing data corresponding to a total exhaust gas discharged from the plurality of gas separation membranes, output, based on a first rate of change associated with the first sensing data and a second rate of change associated with the second sensing data, a signal indicating whether at least one of the plurality of gas separation membranes is defective, and control, based on the signal, a flow path associated with the plurality of gas separation membranes.

The apparatus, wherein the at least one instruction, when executed by the processor communicating with the memory, is configured to cause the apparatus to control a plurality of reference valves of the gas system respectively corresponding to the plurality of gas separation membranes, to selectively connect outlets of the plurality of gas separation membranes to the first pipe, and control a plurality of comparison valves of the gas system respectively corresponding to the plurality of gas separation membranes, to selectively connect outlets of the plurality of gas separation membranes to the second pipe.

The apparatus, wherein the first pipe joins the second pipe at a confluence node of the gas system.

The apparatus, wherein the at least one instruction, when executed by the processor communicating with the memory, is configured to cause the apparatus to open only a reference valve connected with the reference gas separation membrane among the plurality of reference valves, and open comparison valves not connected with the reference gas separation membrane among the plurality of comparison valves.

The apparatus, wherein the at least one instruction, when executed by the processor communicating with the memory, is configured to cause the apparatus to determine that the plurality of gas separation membranes are not defective, based on a difference between the first rate of change of the first sensing data and the second rate of change of the second sensing data being less than a threshold value.

The apparatus, wherein the at least one instruction, when executed by the processor communicating with the memory, is configured to cause the apparatus to determine that a disturbance occurs, based on the difference between the first rate of change and the second rate of change being greater than or equal to the threshold value and a peak being detected from the first rate of change or the second rate of change.

The apparatus, wherein the at least one instruction, when executed by the processor communicating with the memory, is configured to cause the apparatus to determine that the reference gas separation membrane is defective, based on the difference between the first rate of change and the second rate of change being greater than or equal to the threshold value and the first rate of change being greater than the second rate of change.

The apparatus, wherein the at least one instruction, when executed by the processor communicating with the memory, is configured to cause the apparatus to reassign the reference gas separation membrane to another of the plurality of gas separation membranes to serve as the reference gas separation membrane, based on the difference between the first rate of change and the second rate of change being greater than or equal to the threshold value and the second rate of change being greater than the first rate of change.

The apparatus, wherein the at least one instruction, when executed by the processor communicating with the memory, is configured to cause the apparatus to determine, based on the first sensing data, a first concentration of the target gas, wherein at least a portion of the target gas is in the reference exhaust gas, determine, based on the second sensing data, a second concentration of the target gas, wherein at least a portion of the target gas is in the total exhaust gas, and determine, based on a rate of change of the first concentration and a rate of change of the second concentration, whether the reference gas separation membrane is defective.

The apparatus, wherein the at least one instruction, when executed by the processor communicating with the memory, is configured to cause the apparatus to obtain, via a third sensor of the gas system, third sensing data representing a state of the gas mixture, obtain, based on the first sensing data and the third sensing data, a first performance indicator, obtain, based on the second sensing data and the third sensing data, a second performance indicator, and determine, based on a rate of change associated with the first performance indicator and a rate of change associated with the second performance indicator, whether the reference gas separation membrane is defective.

The apparatus, wherein the at least one instruction, when executed by the processor communicating with the memory, is configured to cause the apparatus to determine the first performance indicator and the second performance indicator, further based on at least one of a recovery rate, a purity, a permeance, or a selectivity associated with the target gas.

The apparatus, wherein the at least one instruction, when executed by the processor communicating with the memory, is configured to cause the apparatus to indicate, via a management terminal of the gas system and based on the signal, whether the reference gas separation membrane is defective.

According to the present disclosure, a method performed by an apparatus of a gas system, the method may comprise determining a first rate of change associated with first sensing data corresponding to a reference exhaust gas discharged from a reference gas separation membrane, wherein the reference gas separation membrane is selected from a plurality of gas separation membranes, determining a second rate of change associated with second sensing data corresponding to a total exhaust gas discharged from the plurality of gas separation membranes, outputting, based on the first rate of change and the second rate of change, a signal indicating whether at least one of the plurality of gas separation membranes is defective, and controlling, based on the signal, a flow path associated with the plurality of gas separation membranes.

The method, wherein the outputting of the signal indicating whether at least one of the plurality of gas separation membranes is defective may comprise determining, based on that a difference between the first rate of change and the second rate of change being less than a threshold value, that the plurality of gas separation membranes are not defective.

The method, wherein the outputting of the signal indicating whether at least one of the plurality of gas separation membranes is defective may comprise determining, based on the difference between the first rate of change and the second rate of change being greater than or equal to the threshold value and a peak being detected from the first rate of change or the second rate of change, that a disturbance occurs.

The method, wherein the outputting of the signal indicating whether at least one of the plurality of gas separation membranes is defective may comprise determining, based on the difference between the first rate of change and the second rate of change being greater than or equal to the threshold value and the first rate of change being greater than the second rate of change, that the reference gas separation membrane is defective.

The method may further comprise reassigning the reference gas separation membrane to another of the plurality of gas separation membranes to serve as the reference gas separation membrane, based on the difference being greater than or equal to the threshold value and the second rate of change being greater than the first rate of change.

The method, wherein the outputting the signal indicating whether at least one of the plurality of gas separation membranes is defective may comprise determining, based on the first sensing data, a first concentration of a target gas, wherein at least a portion of the target gas is in the reference exhaust gas, determining, based on the second sensing data, a second concentration of the target gas, wherein at least a portion of the target gas is in the total exhaust gas, and determining, based on a rate of change of the first concentration and a rate of change of the second concentration, whether the reference gas separation membrane is defective.

According to the present disclosure, an apparatus of a gas system, the apparatus may comprise a processor, and a memory storing at least one instruction that, when executed by the processor communicating with the memory, is configured to cause the apparatus to obtain first sensing data indicating characteristics of a reference exhaust gas discharged from a reference membrane selected from a plurality of membranes of the gas system, obtain second sensing data indicating characteristics of a total exhaust gas discharged from the plurality of membranes, output, based on the first sensing data and the second sensing data, a signal indicating whether a deviation exists between the reference exhaust gas and the total exhaust gas, and control, based on the signal, a flow path associated with the plurality of membranes.

The apparatus, wherein the deviation between the reference exhaust gas and the total exhaust gas is determined based on a difference between a first rate of change associated with the first sensing data and a second rate of change associated with the second sensing data.

### BRIEF DESCRIPTION OF THE DRAWINGS

The above and other objects, features and advantages of the present disclosure will be more apparent from the following detailed description taken in conjunction with the accompanying drawings:

FIG. 1 shows an example of a management device of a gas separation system according to an example of the present disclosure;

FIG. 2 shows an example of a separator according to an example of the present disclosure;

FIG. 3 shows an example of a method of managing the gas separation system according to an example of the present disclosure;

FIG. 4 shows an example of a management device of a gas separation system according to another example of the present disclosure;

FIGS. 5A and 5B and FIGS. 6A and 6B are exemplary views for explaining the rate of change of first sensing data and the rate of change of second sensing data;

FIG. 7 shows an example of a method of managing the gas separation system according to the other example of the present disclosure; and

FIG. 8 shows an example of a computing system according to an example of the present disclosure.

### DETAILED DESCRIPTION

Hereinafter, some examples of the present disclosure will be described in detail with reference to the exemplary drawings. In adding the reference numerals to the components of each drawing, it should be noted that the identical or equivalent component is designated by the identical numeral even when they are displayed on other drawings. Further, in describing the example of the present disclosure, a detailed description of well-known features or functions will be ruled out in order not to unnecessarily obscure the gist of the present disclosure.

In describing the components of the example according to the present disclosure, terms such as first, second, “A”, “B”, (a), (b), and the like may be used. These terms are merely intended to distinguish one component from another component, and the terms do not limit the nature, sequence or order of the components. Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

For purposes of this application and the claims, using the exemplary phrase “at least one of: A; B; or C” or “at least one of A, B, or C,” the phrase means 937 at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

The term “module” or “unit” used in the specification means a software and/or hardware component, and the “module” or “unit” performs certain operations/functions/roles. However, the “module” or “unit” is not construed as being limited to software or hardware. The “module” or “unit” may be configured to be in an addressable storage medium or to execute one or more processors. Therefore, as an example, the “module” or “unit” may include at least one of components such as software components, object-oriented software components, class components, and task components, processes, functions, attributes, procedures, sub-routines, segments of program codes, drivers, firmware, micro-codes, circuits, data, databases, data structures, tables, arrays, or variables. Functions provided in the components, “modules”, or “units” may be combined into a smaller number of components, “modules”, or “units” or further divided into additional components, “modules”, or “units”.

In the present disclosure, the “module” or “unit” may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor can read information from a memory and/or record the information in the memory, the memory may be in a state of electronic communication with a processor. Memory integrated into a processor is in a state of electronic communication with the processor.

The one or more features described herein may be provided as a computer program stored in a computer-readable recording medium in order to be executed on a computer. The medium may either continuously store a computer-executable program or temporarily store the program for execution or download. Furthermore, the medium may be a variety of recording or storage means in the form of a single hardware device or multiple combined hardware devices, and is not limited to media directly connected to some computer system but may also be distributed across a network. Examples of such media include magnetic media such as a hard disk, a floppy disk, or a magnetic tape, optical recording media such as a CD-ROM or a DVD, magneto-optical media such as a floptical disk, and a ROM, RAM, or flash memory, among others, configured to store program instructions. Additional examples of such media include media or storage media that are managed by an app store that distributes applications or by various other sites or servers that provide or distribute software.

In a hardware implementation, processing units used for performing the techniques may be implemented within one or more ASICs, DSPs, digital signal processing devices, programmable logic devices, field-programmable gate arrays, processors, controllers, microcontrollers, microprocessors, electronic devices, or computers or combinations thereof designed to perform the functions described in the present disclosure.

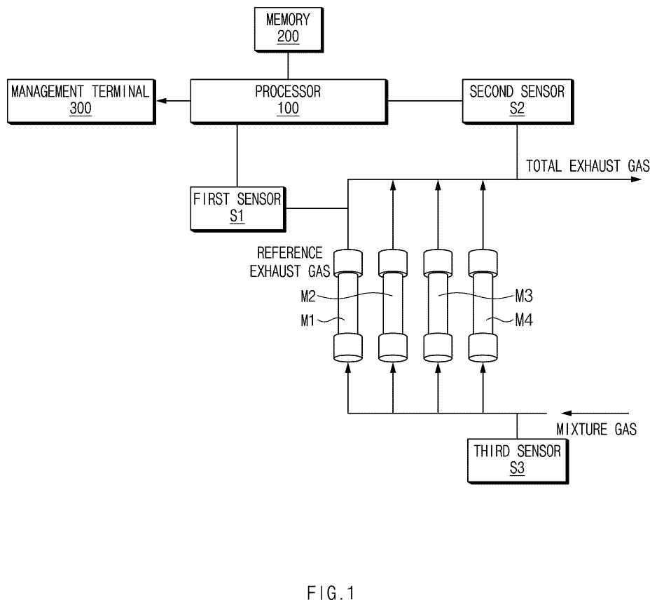

Hereinafter, examples of the present disclosure will be described in detail with reference to FIGS. 1 to 8.

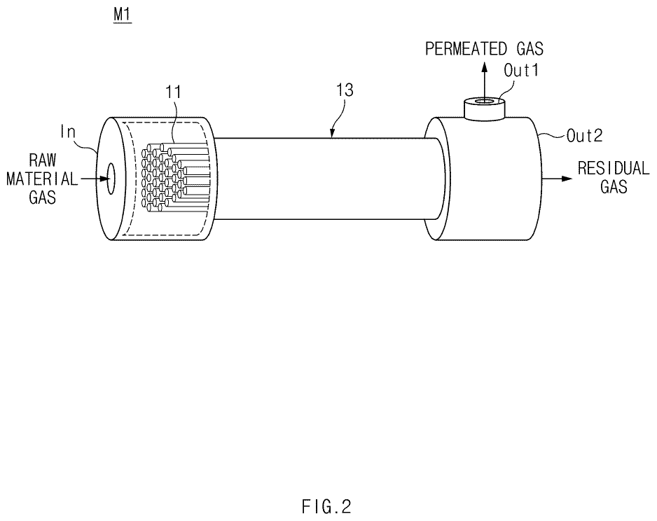

FIG. 1 shows an example of a management device of a gas separation system according to an example of the present disclosure. FIG. 2 shows an example of a separator according to an example of the present disclosure.

Referring to FIG. 1 and FIG. 2, the management device of the gas separation system according to an example of the present disclosure may serve to determine defects or performance degradation in a plurality of separators M1 to M4 and may include first to third sensors S1, S2, and S3, a processor 100, a memory 200, and a management terminal 300.

As illustrated in FIG. 2, the first separator M1 may include a plurality of separation membranes 11 formed in a housing 13.

The separation membranes 11 may be formed of a material such as a polymeric compound (e.g., polysulfone, polyimide, or polyether ether ketone), an inorganic ceramic material (e.g., zeolite, alumina, or titania), or solid carbon (e.g., carbon molecular sieve or activated carbon), etc. The separation membranes 11 may be formed in a tubular shape (e.g., capillary-type), a hollow fiber membrane shape (e.g., spaghetti-like strands), or a spiral shape (e.g., wound flat-sheet membrane), etc.

A raw material gas introduced into an inlet of the housing 13 may pass through the separation membranes 11 and may be discharged through a first outlet Out1 or a second outlet Out2. The gas discharged through the first outlet Out1 may be a permeated gas that has passed through the separation membranes. The gas discharged through the second outlet Out2 may be a residual gas containing gases (e.g., other than the permeated gas) that did not pass through the membranes. The permeated gas or the residual gas may be referred to as an exhaust gas (e.g., hydrogen, carbon dioxide, nitrogen, or methane, depending on application).

The second to fourth separators M2, M3, and M4 may have the same structure as the first separator M1 illustrated in FIG. 2.

Although FIG. 1 illustrates the gas separation system including four separators M1 to M4, the number of separators included in the gas separation system may not be limited thereto.

The raw material gas may be a mixture gas containing a plurality of gases (e.g., carbon dioxide, methane, hydrogen, nitrogen, or oxygen, etc.). The raw material gas supplied to the first to fourth separators M1 to M4 may have undergone a pretreatment process for removing impurities such as moisture, dust, oil mist, or sulfur compounds, etc.

The first sensor S1 may serve to obtain sensing data on a reference exhaust gas discharged from the reference separator M1. Hereinafter, the sensing data obtained by the first sensor S1 may be referred to as the first sensing data. The reference separator M1 may be a selected one of the first to fourth separators M1 to M4, and FIG. 1 illustrates a state in which the first separator M1 is selected as the reference separator. The reference exhaust gas may mean the exhaust gas passing through the reference separator M1 and may be the residual gas or the permeated gas that passes through the first separator M1. The first sensor S1 may include a sensor for determining the composition of the reference exhaust gas (e.g., concentration of target gases such as CO₂ or CH₄, etc.) and may include sensors for determining the temperature, the pressure, and the flow rate of the reference exhaust gas, in addition to that.

The second sensor S2 may serve to obtain sensing data on a total exhaust gas discharged from the first to fourth separators M1 to M4. Hereinafter, the sensing data obtained by the second sensor S2 may be referred to as the second sensing data. The second sensor S2 may serve to obtain the second sensing data on the total exhaust gas into which the exhaust gases passing through the first to fourth separators M1 to M4 including the reference separator M1 merge. The total exhaust gas may be the residual gas or the permeated gas that passes through the first to fourth separators M1 to M4. The second sensor S2 may include sensors for determining the temperature, the pressure, the flow rate, and the composition of the total exhaust gas (e.g., combined gas purity or impurity concentrations, etc.).

The third sensor S3 may serve to obtain sensing data on the raw material gas. Hereinafter, the sensing data obtained by the third sensor S3 may be referred to as the third sensing data. The third sensor S3 may include sensors for determining the temperature, the pressure, the flow rate, and the composition of the raw material gas (e.g., identifying inlet gas ratios such as 60% methane and 40% carbon dioxide, etc.).

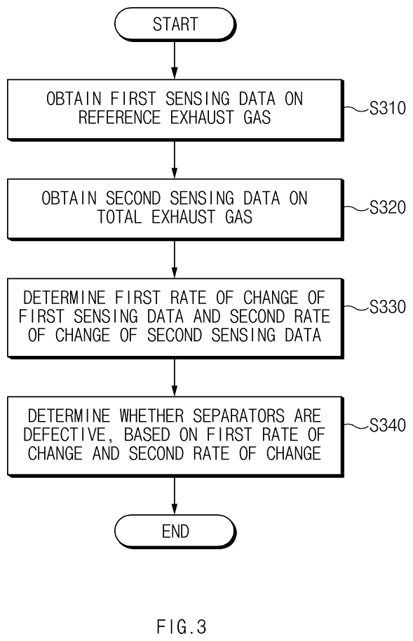

The processor 100 may determine whether the first to fourth separators M1 to M4 are defective, based on the rate of change of the first sensing data and the rate of change of the second sensing data. The procedure for determining, by the processor 100, whether the first to fourth separators M1 to M4 are defective will be described below with reference to FIG. 3.

The memory 200 may be a storage medium in which an algorithm for an operation of the processor 100 is recorded. The memory 200 may use a hard disk drive, a flash memory, an electrically erasable programmable read-only memory (EEPROM), a static RAM (SRAM), a ferro-electric RAM (FRAM), a phase-change RAM (PRAM), a magnetic RAM (MRAM), a dynamic random access memory (DRAM), a synchronous dynamic random access memory (SDRAM), or a double date rate-SDRAM (DDR-SDRAM).

The processor 100 may provide, to the management terminal 300, a result obtained by monitoring the gas separation system.

The result obtained by monitoring the gas separation system may include information about a defective separator (e.g., identification of a separator with abnormal gas concentration trends, pressure drops, or flow inconsistencies, etc.).

In addition, the result obtained by monitoring the gas separation system may include a phenomenon in which the gas separation performance is deteriorated by a disturbance occurring outside the first to fourth separators M1 to M4, for example, an impact applied to the first to fourth separators M1 to M4 (e.g., a fluctuation in feed gas composition, a temperature spike, or a mechanical shock to piping or support structures, etc.).

The processor 100 may provide the monitoring result to the management terminal 300 using wired communication or wireless communication, and to this end, the processor 100 may control a communication module (not illustrated).

FIG. 3 shows an example of a method of managing the gas separation system according to an example of the present disclosure. The method of managing the gas separation system according to the example of the present disclosure will be described with reference to FIG. 3.

In step S310, the first sensor S1 may obtain the first sensing data on the reference exhaust gas discharged from the reference separator M1 (e.g., pressure, temperature, flow rate, or component concentration, etc.).

In step S320, the second sensor S2 may obtain the second sensing data on the total exhaust gas discharged from the first to fourth separators M1 to M4.

In step S330, the processor 100 may determine a first rate of change of the first sensing data and a second rate of change of the second sensing data. The first rate of change may represent the degree to which the first sensing data varies (e.g., increases or decreases) over time. The second rate of change may represent the degree to which the second sensing data varies (e.g., increases or decreases) over time (e.g., changes in corresponding properties measured from the combined output of all separators, etc.).

In step S340, the processor 100 may determine whether the first to fourth separators M1 to M4 are defective, by comparing the first rate of change and the second rate of change.

In addition, step S340 may include a procedure for determining, by the processor 100, a phenomenon in which the gas separation performance is deteriorated by a disturbance occurring outside the first to fourth separators M1 to M4.

According to an example, the processor 100 may determine that the first to fourth separators M1 to M4 are not defective, if the difference between the first rate of change and the second rate of change is less than a threshold value. The threshold value may be an empirically determined preset value (e.g., a change of less than 2% in composition or less than 0.1 bar in pressure, etc.).

Furthermore, the processor 100 may determine that a disturbance occurs, if the difference between the first rate of change and the second rate of change is greater than or equal to the threshold value and a peak is detected from the first rate of change and the second rate of change. The peak may be a phenomenon in which the first sensing data or the second sensing data rapidly undergo a rapid fluctuation followed by recovery within a defined time window (e.g., a sudden drop in pressure followed by normalization, or a momentary spike in gas concentration, etc.).

In addition, the processor 100 may determine that the reference separator M1 is defective, if the difference between the first rate of change and the second rate of change is greater than or equal to the threshold value and the first rate of change is greater than the second rate of change (e.g., indicating a disproportionately faster change in gas composition at the reference separator compared to the overall system, etc.).

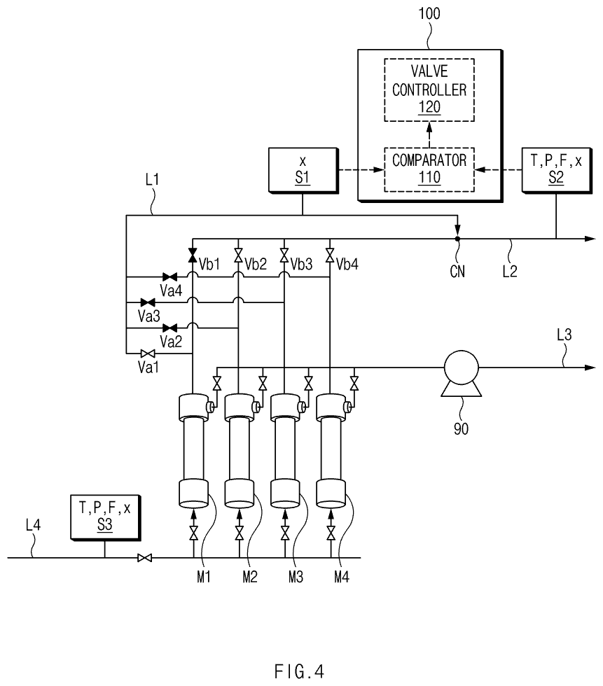

FIG. 4 shows an example of a management device of a gas separation system according to another example of the present disclosure. Detailed description of components substantially the same as those illustrated in FIG. 1 will be omitted.

Referring to FIG. 4, the management device of the gas separation system according to the other example of the present disclosure may include first to third sensors S1 to S3, first to fourth reference valves Va1 to Va4, first to fourth comparison valves Vb1 to Vb4, a vacuum pump 90, a processor 100, and a memory 200 (e.g., implemented as a microcontroller, FPGA, or industrial PC, etc.).

The first sensor S1 may be connected to a first pipe L1 and may obtain first sensing data on a reference exhaust gas discharged from a reference separator M1. The reference separator M1 may be a separator selected from among the first to fourth separators M1 to M4, and FIG. 4 illustrates an example in which the first separator M1 is selected as the reference separator (e.g., based on its representative gas composition, stable baseline performance, or proximity to the sensing equipment, etc.). The reference exhaust gas may mean the exhaust gas passing through the reference separator M1 and may be the residual gas passing through the first separator M1. The first sensor S1 may include a sensor for determining the composition x of the reference exhaust gas (e.g., mole fraction of CO₂, N₂, CH₄, or H₂, etc.) and may include sensors for determining the temperature T, the pressure P, and the flow rate F of the reference exhaust gas, in addition to that.

The second sensor S2 may be connected to a second pipe L2 and may obtain second sensing data on a total exhaust gas discharged from the first to fourth separators M1 to M4. The total exhaust gas may be the combined residual gas stream into which the residual gases passing through the first to fourth separators M1 to M4 are merged (e.g., via a common manifold, collection header, or junction, etc.). The second sensor S2 may include sensors for determining the temperature T, the pressure P, the flow rate F, and the composition x of the total exhaust gas (e.g., bulk concentration of target and non-target gases in the combined stream, etc.).

The third sensor S3 may be connected to a fourth pipe L4 and may obtain sensing data on a raw material gas. Hereinafter, the sensing data obtained by the third sensor S3 may be referred to as the third sensing data. The third sensor S3 may include sensors for determining the temperature T, the pressure P, the flow rate F, and the composition x of the raw material gas (e.g., relative concentrations of methane, carbon dioxide, hydrogen sulfide, or nitrogen, etc.).

The first to fourth reference valves Va1 to Va4 may match the first to fourth separators M1 to M4, respectively (e.g., each valve corresponding to a dedicated separator module to manage selective exhaust routing, etc.).

The first to fourth reference valves Va1 to Va4 may serve to selectively connect outlets of the first to fourth separators M1 to M4 with the first pipe L1. Each of the outlets of the first to fourth separators M1 to M4 may be the first outlet Out1 illustrated in FIG. 2. The first pipe L1 may be a pipe to which the first sensor S1 is connected (e.g., to isolate and measure reference exhaust characteristics during normal or diagnostic operation, etc.).

The first to fourth comparison valves Vb1 to Vb4 may match the first to fourth separators M1 to M4, respectively.

The first to fourth comparison valves Vb1 to Vb4 may serve to selectively connect the outlets of the first to fourth separators M1 to M4 with the second pipe L2. Each of the outlets of the first to fourth separators M1 to M4 may be the first outlet Out1 illustrated in FIG. 2. The second pipe L2 may be a pipe to which the second sensor S2 is connected and may join the first pipe L1 at a confluence node CN (e.g., a Y-junction or multi-port manifold enabling combined flow analysis, etc.).

The vacuum pump 90 may serve to form a partial pressure difference between the inlets In and the first outlets Out1 of the first to fourth separators M1 to M4 for gas separation of the first to fourth separators M1 to M4. To this end, the vacuum pump 90 may lower the pressure of a third pipe L3 connected with the first outlets Out1 of the first to fourth separators M1 to M4 (e.g., to facilitate selective gas permeation driven by transmembrane pressure gradient, etc.).

The processor 100 may include a comparator 110 and a valve controller 120. The comparator 110 may determine whether the first to fourth separators M1 to M4 are defective, based on the first rate of change of the first sensing data and the second rate of change of the second sensing data (e.g., by evaluating whether the difference between the first and second rate of changes exceeds a predefined threshold indicative of abnormal separator behavior, etc.). The valve controller 120 may control opening and closing of the first to fourth reference valves Va1 to Va4 and the first to fourth comparison valves Vb1 to Vb4. In the following description, the comparator 110 and the valve controller 120 may be implemented as separate processors or as a single processor (e.g., depending on hardware integration, computational load distribution, or redundancy requirements, etc.). In the following description, an example of the processor 100 in which the comparator 110 and the valve controller 120 are integrated will be described.

The processor 100 may control the first to fourth reference valves Va1 to Va4 and the first to fourth comparison valves Vb1 to Vb4 to determine a flow path along the first pipe L1 and the second pipe L2, when the reference separator M1 is determined (e.g., to isolate the reference exhaust for comparison against system-wide exhaust data, etc.).

The reference separator M1 may be any one separator selected at random from the first to fourth separators M1 to M4.

Alternatively, based on a test run, the processor 100 may select a separator that discharges a residual gas having a composition most similar to the composition of the total residual gas of the first to fourth separators M1 to M4 as the reference separator (e.g., the separator whose exhaust gas shows minimal deviation from the system-wide average under steady-state conditions, etc.).

Additionally, the reference separator M1 may be changed (e.g., dynamically) in a monitoring process (e.g., when performance drift or inconsistency is detected, or when validation of a different separator is required, etc.).

To obtain the first sensing data on the exhaust gas of the reference separator, the processor 100 may open only the reference valve connected with the reference separator and may close the other reference valves (e.g., to isolate flow from the selected module for comparative sensing purposes, etc.).

For example, when the first separator M1 is the reference separator, the processor 100 may open the first separator M1 and the first reference valve Va1 and may close the second to fourth reference valves Va2 to Va4. Accordingly, the exhaust gas discharged from the first separator M1 may flow through the first pipe L1 (e.g., exclusively).

The processor 100 may close the comparison valve connected with the reference separator and may open the comparison valves not connected with the reference separator (e.g., to route non-reference exhaust gases toward system-wide monitoring, etc.).

For example, when the first separator M1 is the reference separator, the processor 100 may close the first comparison valve Vb1 connected with the first separator M1 and may open the second to fourth comparison valves Vb2 to Vb4. Accordingly, the exhaust gas discharged from the second to fourth separators M2 to M4 may be introduced into the second pipe L2 (e.g., to allow collective monitoring of non-reference exhaust streams while isolating the reference stream for separate analysis, etc.). In addition, the exhaust gas discharged from the first separator M1 may pass through the first pipe L1 and may flow into the second pipe L2 at the confluence node CN (e.g., enabling downstream combined measurement of both flows at a common point, etc.).

The processor 100 may determine whether the first to fourth separators M1 to M4 are defective, based on the rate of change of the first sensing data and the rate of change of the second sensing data (e.g., by identifying deviations that exceed a predefined statistical or empirical threshold, etc.).

The first sensing data and the second sensing data may be information on the temperature, the pressure, the flow rate, and the composition of the gas (e.g., using sensors calibrated for CO₂%, CH₄ ppm, or H₂ partial pressure, etc.).

In addition, the first sensing data and the second sensing data may be used to calculate performance indicators based on data obtained by the first sensor S1 and the second sensor S2. The processor 100 may determine a first performance indicator representing the performance of the reference separator, based on the first sensing data and the third sensing data (e.g., calculating recovery rate, purity, or permeance using feed and exhaust conditions, etc.). Additionally, the processor 100 may determine a second performance indicator representing the performance of the first to fourth separators M1 to M4, based on the second sensing data and the third sensing data (e.g., recovery rate, purity, or selectivity values derived through gas flow and concentration comparisons, etc.).

The performance indicators may include recovery rate, purity, permeance, and selectivity (e.g., depending on the application requirements such as CO2 capture efficiency, hydrogen purity for fuel cells, or methane enrichment from biogas, etc.).

The recovery rate may mean the amount of a target gas contained in the residual gas or the permeated gas in comparison with the total amount of the raw material gas (e.g., the fraction of CO₂ recovered from a flue gas mixture, etc.).

The purity may mean the concentration of the target gas within the residual gas or the permeated gas (e.g., methane concentration in the permeate stream after separation of CO₂ and other impurities, etc.).

The permeance may represent the rate at which a gas permeates a membrane (e.g., a membrane per unit area and unit pressure difference, expressed in GPU or Barrer, where higher values indicate faster transport across the membrane, etc.).

The selectivity may be a value obtained by dividing the permeance of each gas when two or more gases permeate a membrane (e.g., dividing the permeance of a target gas by the permeance of a reference gas when two or more gases permeate a membrane, such as H₂/CO₂ selectivity, or CO₂/CH₄ selectivity, depending on the separation task, etc.).

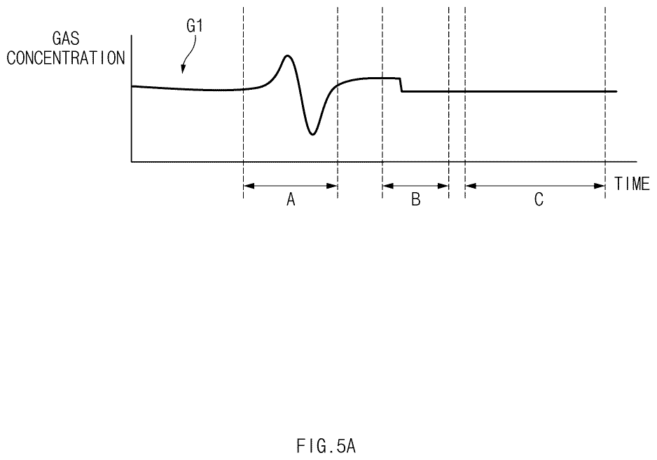

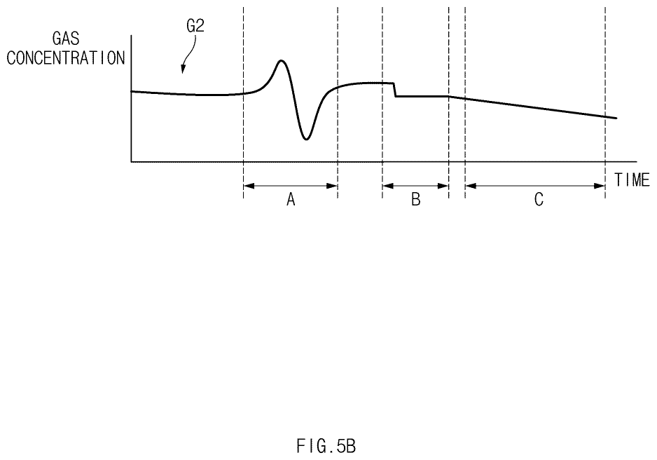

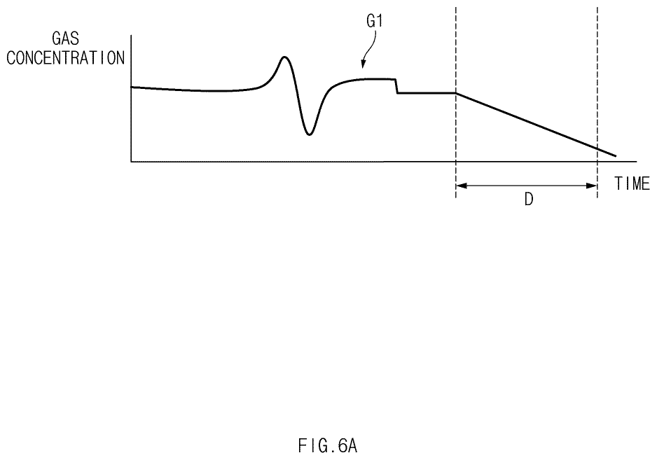

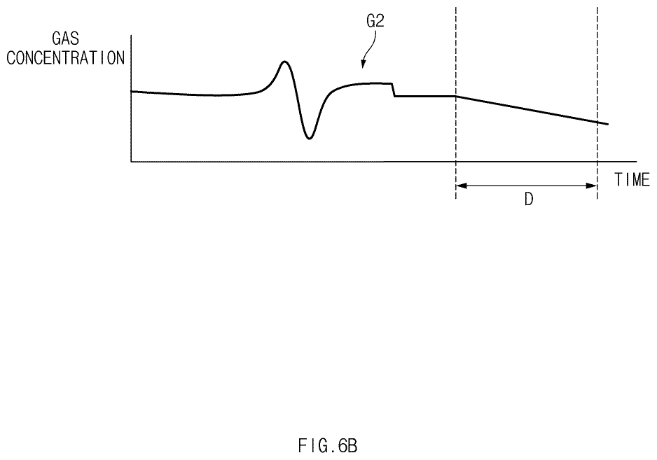

When the rate of change of the first sensing data is referred to as the first rate of change and the rate of change of the second sensing data is referred to as the second rate of change, the processor 100 may determine whether the separators are defective, based on the difference between the first rate of change and the second rate of change (e.g., by detecting abnormal variations in performance metrics between the reference and overall system behavior, etc.). A method of determining, by the processor, whether the separators are defective will be described below with reference to FIG. 5A, FIG. 5B, FIG. 6A and FIG. 6B.

FIG. 5A, FIG. 5B, FIG. 6A and FIG. 6B are exemplary views for explaining the rate of change of the first sensing data and the rate of change of the second sensing data. FIG. 5A, FIG. 5B, FIG. 6A and FIG. 6B are views illustrating results obtained by monitoring changes in the gas concentrations of target gases based on the composition included in the sensing data. In FIG. 5A and FIG. 6A, the first graph G1 depicts a change in the gas concentration of the reference exhaust gas (e.g., over time). In FIG. 5B and FIG. 6B, the second graph G2 depicts a change in the gas concentration of the total exhaust gas (e.g., over time). In the following description, an example in which the first separator is determined as the reference separator will be described.

According to an example, the processor 100 may determine that the first to fourth separators M1 to M4 are not defective, if the difference between the first rate of change and the second rate of change is less than a threshold value (e.g., within 1-2% variation in gas concentration trend lines over time, etc.).

For example, the period A of FIG. 5A and FIG. 5B is a period in which the difference between the first rate of change and the second rate of change is determined to be less than the threshold value and indicates that the gas concentration of the total exhaust gas and the gas concentration of the reference exhaust gas vary in a closely matching pattern (e.g., exhibiting parallel trends or synchronized fluctuations, etc.). In the period A of FIG. 5A and FIG. 5B, the performance of the reference separator M1 is very similar to the performance of the other separators M2 to M4. Accordingly, it may be determined that the first to fourth separators M1 to M4 are not defective (e.g., indicating stable system operation without individual module failures, etc.).

According to an example, the processor 100 may determine that a disturbance occurs, if the difference between the first rate of change and the second rate of change is greater than or equal to the threshold value and a peak is detected from the first rate of change and/or the second rate of change (e.g., a sudden but temporary spike or dip followed by recovery, etc.).

When the first to fourth separators M1 to M4 are not defective, the rate of change of the first graph G1 and the rate of change of the second graph G2 are usually maintained close to 0 (zero) as in the period B of FIG. 5A and FIG. 5B (e.g., indicating steady-state performance with minimal variation in gas composition over time, etc.).

However, as in the period A of FIG. 5A and FIG. 5B, the same pattern of peaks may occur in the first graph G1 and the second graph G2, and it may be determined that an abnormality in gas separation performance has temporarily occurred due to a disturbance rather than a problem with the first to fourth separators M1 to M4 (e.g., feed gas fluctuation, vibration, or pressure surge, etc.).

According to an example, the processor 100 may change the reference separator if the difference between the first rate of change and the second rate of change is greater than or equal to the threshold value and the first rate of change is less than the second rate of change.

When the gas separation performance of the reference separator M1 is different from the other separators M2 to M4, the difference between the first rate of change and the second rate of change may be greater than or equal to the threshold value (e.g., indicating inconsistent behavior that suggests a defect or degradation in one or more modules, etc.). In addition, a relatively large rate of change may occur when the performance of a separator deteriorates. Therefore, if the difference between the first rate of change and the second rate of change is greater than or equal to the threshold value and the first rate of change is less than the second rate of change as in the period C of FIG. 5A and FIG. 5B, it may be determined that at least one of the second to fourth separators M2 to M4 is defective (e.g., due to membrane fouling, physical damage, or loss of selectivity, etc.). Accordingly, to specify a defective separator, the reference separator may be changed (e.g., by rotating through the remaining separators until a localized anomaly is detected, etc.).

The processor 100 may re-determine whether the first to fourth separators M1 to M4 are defective, by controlling the reference valves Va1 to Va4 and the comparison valves Vb1 to Vb4 based on the changed reference separator (e.g., by rerouting exhaust flow paths and updating the reference sensor input accordingly, etc.).

According to an example, the processor 100 may determine that the reference separator is defective, if the difference between the first rate of change and the second rate of change is greater than or equal to the threshold value and the first rate of change is greater than the second rate of change (e.g., indicating the reference separator is drifting out of normal performance range while the rest remain stable, etc.).

In FIG. 6A and FIG. 6B, the period D shows that the first rate of change is greater than the second rate of change. The period D of FIG. 6A and FIG. 6B may represent a state in which the performance of the reference separator M1 is deteriorated, and accordingly the processor 100 may determine that the reference separator M1 is defective.

The gas separation system according to the other example illustrated in FIG. 4 may further include a management terminal for displaying a monitoring result (e.g., a GUI showing module health, trend graphs, or alert notifications, etc.).

In the example illustrated in FIG. 4, the first sensor S1 and the second sensor S2 are connected to the second pipe L2 to obtain the second sensing data related to the residual gas (e.g., including parameters such as temperature, pressure, composition, and flow rate, etc.). According to another example of the present disclosure, the sensors for obtaining the second sensing data may be connected to the third pipe L3, and the processor 100 may determine whether the first to fourth separators M1 to M4 are defective, based on the sensing data of the permeated gas (e.g., by evaluating changes in gas purity, flow rate, or composition on the permeate side, etc.). To this end, the reference valves Va1 to Va4 and the comparison valves Vb1 to Vb4 may be connected to the third pipe L3 (e.g., to enable the same comparative monitoring logic applied to the permeate side instead of the residual side, etc.).

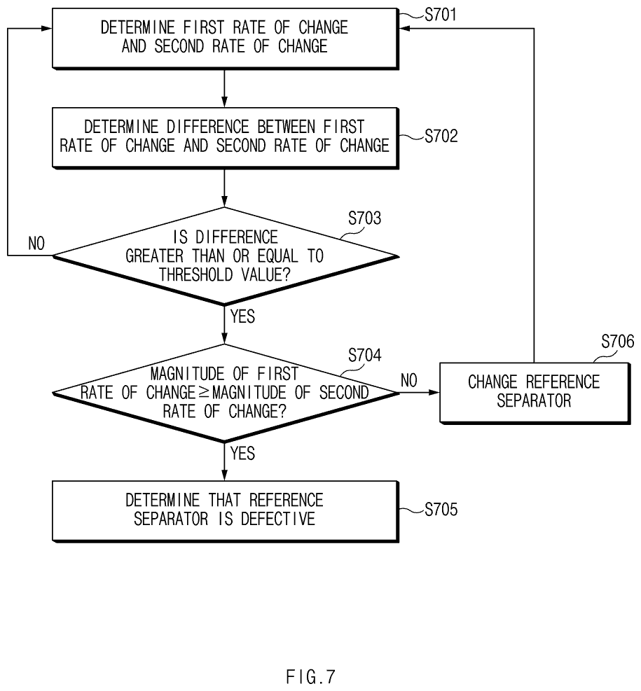

FIG. 7 shows an example of a method of managing the gas separation system according to the other example of the present disclosure. The method of managing the gas separation system according to the other example of the present disclosure will be described with reference to FIG. 7.

In step S701, the processor 100 may determine the first rate of change and the second rate of change.

The first rate of change may be the rate of change of the first sensing data obtained by the first sensor S1.

Alternatively, the first rate of change may be the rate of change of the performance indicator obtained based on the first sensing data. For example, the first rate of change may indicate the rate of change in the concentration of a target gas discharged from the reference separator M1.

The second rate of change may be the rate of change of the second sensing data obtained by the second sensor S2. The second rate of change may be the rate of change of the performance indicator obtained based on the second sensing data (e.g., changes in gas concentration, flow rate, or pressure over time, etc.). For example, the second rate of change may indicate the rate of change in the concentration of a target gas discharged from the first to fourth separators M1 to M4.

The processor 100 may determine the first rate of change and the second rate of change, based on the first sensing data and the second sensing data obtained at predetermined time intervals. The first rate of change may be determined based on the degree to which the first sensing data changes (e.g., increases or decreases) per unit time. The unit time may be equal to the sampling interval of the first sensing data or may be set to be greater than the sampling interval (e.g., 5 seconds, 10 seconds, or 30 seconds, etc.).

Similarly, the second rate of change may represent the degree to which the second sensing data changes (e.g., increases or decreases) per unit time.

In step S702, the processor 100 may determine the difference between the first rate of change and the second rate of change.

In step S703, the processor 100 may compare the difference between the first rate of change and the second rate of change with the threshold value (e.g., a deviation tolerance determined through empirical calibration, etc.).

The processor 100 may return to step S701 if the difference between the first rate of change and the second rate of change is determined to be less than the threshold value.

In step S704, the processor 100 may compare the magnitude of the first rate of change and the magnitude of the second rate of change, given that the difference between the first rate of change and the second rate of change is greater than or equal to the threshold value.

The magnitude of the rate of change may refer to the absolute value of the rate of change. The processor 100 may determine which of the first sensing data and the second sensing data has a smaller variation by comparing the magnitude of the first rate of change and the magnitude of the second rate of change.

In step S705, the processor 100 may determine that the reference separator is defective, based on the fact that the magnitude of the first rate of change is greater than the magnitude of the second rate of change (e.g., suggesting abnormal performance localized to the currently monitored separator, etc.).

In step S706, the processor 100 may change the reference separator, based on the fact that the magnitude of the first rate of change is less than the magnitude of the second rate of change.

If the magnitude of the first rate of change is less than the magnitude of the second rate of change, the processor 100 may indicate that a problem exists in one or more of the remaining separators M2 to M4. However, because a defective separator is not specified only by the determination that the performance of the system including the first to fourth separators M1 to M4 is deteriorated, the processor 100 may change the reference separator.

The procedure of changing the reference separator may include a step of controlling the first to fourth reference valves Va1 to Va4 and the first to fourth comparison valves Vb1 to Vb4 (e.g., to reroute gas flows and isolate a new module for targeted sensing, etc.).

If the second separator M2 is designated as a new reference separator, the processor 100 may open the second reference valve Va2 connected with the second separator M2. The processor 100 may close the first, third, and fourth reference valves Va1, Va3, and Va4, respectively.

In addition, the processor 100 may close the second comparison valve Vb2 connected with the second separator M2 and may open the first, third, and fourth comparison valves Vb1, Vb3, and Vb4, respectively.

After setting the second separator M2 as the reference separator, the processor 100 may determine whether the second separator M2 is defective based on the first sensing data corresponding to the reference exhaust gas discharged from the second separator M2 and the second sensing data corresponding to the total exhaust gas discharged from the first to fourth separators M1 to M4.

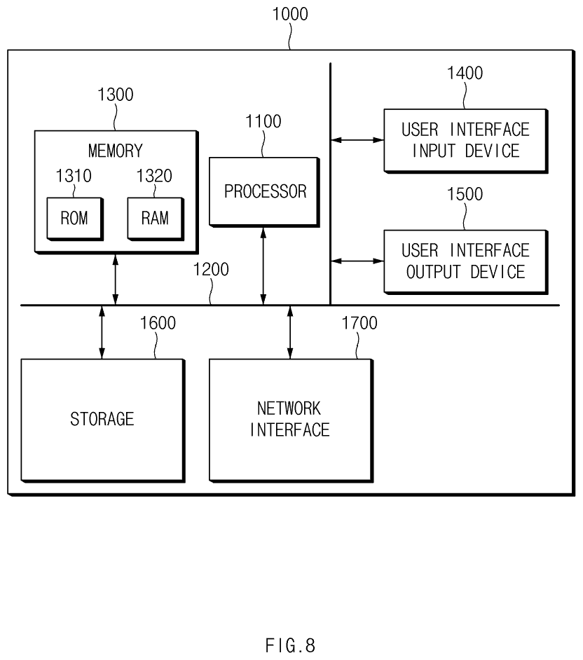

FIG. 8 illustrates a computing system according to an example of the present disclosure.

Referring to FIG. 8, the computing system 1000 may include at least one processor 1100, a memory 1300, a user interface input device 1400, a user interface output device 1500, storage 1600, and a network interface 1700, which are connected with each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media (e.g., dynamic RAM, flash memory, EEPROM, or solid-state drives, etc.). For example, the memory 1300 may include a ROM (Read Only Memory) 1310 and a RAM (Random Access Memory) 1320.

Thus, the operations of the method or the algorithm described in connection with the examples disclosed herein may be embodied directly in hardware or a software module executed by the processor 1100, or in a combination thereof. The software module may reside on a storage medium (e.g., the memory 1300 and/or the storage 1600) such as a RAM, a flash memory, a ROM, an EPROM, an EEPROM, a register, a hard disk, a removable disk, or a CD-ROM.

The exemplary storage medium may be coupled to the processor 1100, and the processor 1100 may read information from the storage medium and may record information in the storage medium. Alternatively, the storage medium may be integrated with the processor 1100. The processor 1100 and the storage medium may reside in an application specific integrated circuit (ASIC). The ASIC may reside within a user terminal. In another case, the processor 1100 and the storage medium may reside in the user terminal as separate components.

An example of the present disclosure provides a gas separation system and a management method thereof for saving costs while reducing working time.

Another example of the present disclosure provides a gas separation system and a management method thereof for identifying a defective separator in real time.

The technical problems to be solved by the present disclosure are not limited to the aforementioned problems, and any other technical problems not mentioned herein will be clearly understood from the following description by those skilled in the art to which the present disclosure pertains.

According to an example of the present disclosure, a gas separation system includes a plurality of separators that separate a specific gas from a mixture gas, a first sensor connected with a first pipe through which a reference exhaust gas discharged from a reference separator selected from the separators passes, a second sensor connected with a second pipe through which a total exhaust gas discharged from the separators passes, and a processor that determines whether the separators are defective, based on a rate of change of first sensing data obtained by the first sensor and a rate of change of second sensing data obtained by the second sensor.

According to an example, the gas separation system may further include reference valves that match the separators, respectively, and selectively connect outlets of the separators with the first pipe and comparison valves that match the separators, respectively, and selectively connect the outlets of the separators with the second pipe.

According to an example, the first pipe may join the second pipe at a confluence node.

According to an example, the processor may open only a reference valve connected with the reference separator among the reference valves and may open comparison valves not connected with the reference separator among the comparison valves.

According to an example, the processor may determine that the separators are not defective, if a difference between a first rate of change of the first sensing data and a second rate of change of the second sensing data is less than a threshold value.

According to an example, the processor may determine that a disturbance occurs, if the difference is greater than or equal to the threshold value and a peak is detected from the first rate of change or the second rate of change.

According to an example, the processor may determine that the reference separator is defective, if the difference is greater than or equal to the threshold value and the first rate of change is greater than the second rate of change.

According to an example, the processor may change the reference separator, if the difference is greater than or equal to the threshold value and the second rate of change is greater than the first rate of change.

According to an example, the processor may determine a first concentration of a specific gas in the reference exhaust gas, based on the first sensing data, may determine a second concentration of the specific gas in the total exhaust gas, based on the second sensing data, and may determine whether the reference separator is defective, based on a rate of change of the first concentration and a rate of change of the second concentration.

According to an example, the gas separation system may further include a third sensor that obtains third sensing data representing a state of the mixture gas. The processor may obtain a first performance indicator, based on the first sensing data and the third sensing data, may obtain a second performance indicator, based on the second sensing data and the third sensing data, and may determine whether the reference separator is defective, based on a rate of change of the first performance indicator and a rate of change of the second performance indicator.

According to an example, the processor may determine the first performance indicator and the second performance indicator, based on one of recovery rate, purity, permeance, and selectivity.

According to an example, the gas separation system may further include a management terminal that informs whether the reference separator is defective, based on a determination result of the processor.

According to another example of the present disclosure, a method for managing a gas separation system includes a step of determining, by a processor, a first rate of change of first sensing data on a reference exhaust gas discharged from a reference separator selected from a plurality of separators, a step of determining, by the processor, a second rate of change of second sensing data on a total exhaust gas discharged from the separators, and a step of determining, by the processor, whether the separators are defective, based on the first rate of change and the second rate of change.

According to an example, the step of determining whether the separators are defective may include a step of determining that the separators are not defective, if a difference between the first rate of change and the second rate of change is less than a threshold value.

According to an example, the step of determining whether the separators are defective may include a step of determining that a disturbance occurs, if the difference is greater than or equal to the threshold value and a peak is detected from the first rate of change or the second rate of change.

According to an example, the step of determining whether the separators are defective may include a step of determining that the reference separator is defective, if the difference is greater than or equal to the threshold value and the first rate of change is greater than the second rate of change.

According to an example, the method may further include a step of changing the reference separator if the difference is greater than or equal to the threshold value and the second rate of change is greater than the first rate of change.

According to an example, the step of determining whether the separators are defective may include a step of determining a first concentration of a specific gas in the reference exhaust gas, based on the first sensing data, a step of determining a second concentration of the specific gas in the total exhaust gas, based on the second sensing data, and a step of determining whether the reference separator is defective, based on a rate of change of the first concentration and a rate of change of the second concentration.

According to an example, the method may further include a step of obtaining, by a third sensor, third sensing data representing a state of the mixture gas. The step of determining whether the separators are defective may include a step of obtaining a first performance indicator, based on the first sensing data and the third sensing data, a step of obtaining a second performance indicator, based on the second sensing data and the third sensing data, and a step of determining whether the reference separator is defective, based on a rate of change of the first performance indicator and a rate of change of the second performance indicator.

According to an example, each of the first performance indicator and the second performance indicator may be selected from recovery rate, purity, permeance, and selectivity.

According to the examples of the present disclosure, a device for determining gas separation performance does not have to be provided for each separator, and therefore the cost of construction of a system for monitoring may be reduced.

Furthermore, according to the examples of the present disclosure, whether the plurality of separators are defective may be determined in real time by monitoring the exhaust gases discharged by the separators in real time.

In addition, the present disclosure may provide various effects that are directly or indirectly recognized.

Hereinabove, although the present disclosure has been described with reference to examples and the accompanying drawings, the present disclosure is not limited thereto, but may be variously modified and altered by those skilled in the art to which the present disclosure pertains without departing from the spirit and scope of the present disclosure claimed in the following claims.

Therefore, the examples of the present disclosure are provided to explain the spirit and scope of the present disclosure, but not to limit them, so that the spirit and scope of the present disclosure is not limited by the examples. The scope of the present disclosure should be construed on the basis of the accompanying claims, and all the technical ideas within the scope equivalent to the claims should be included in the scope of the present disclosure.

What is claimed:

1. An apparatus of a gas system, the apparatus comprising:
a processor; and
a memory storing at least one instruction that, when executed by the processor communicating with the memory, is configured to cause the apparatus to:
separate a target gas from a gas mixture using a plurality of gas separation membranes of the gas system;
obtain, via a first sensor of the gas system connected with a first pipe of the gas system, first sensing data corresponding to a reference exhaust gas discharged from a reference gas separation membrane selected from the plurality of gas separation membranes;
obtain, via a second sensor of the gas system connected with a second pipe of the gas system, second sensing data corresponding to a total exhaust gas discharged from the plurality of gas separation membranes; and
output, based on a first rate of change associated with the first sensing data and a second rate of change associated with the second sensing data, a signal indicating whether at least one of the plurality of gas separation membranes is defective.

2. The apparatus of claim 1, wherein the at least one instruction, when executed by the processor communicating with the memory, is configured to cause the apparatus to:
control a plurality of reference valves of the gas system respectively corresponding to the plurality of gas separation membranes, to selectively connect outlets of the plurality of gas separation membranes to the first pipe; and
control a plurality of comparison valves of the gas system respectively corresponding to the plurality of gas separation membranes, to selectively connect outlets of the plurality of gas separation membranes to the second pipe.

3. The apparatus of claim 2, wherein the first pipe joins the second pipe at a confluence node of the gas system.

4. The apparatus of claim 2, wherein the at least one instruction, when executed by the processor communicating with the memory, is configured to cause the apparatus to:
open only a reference valve connected with the reference gas separation membrane among the plurality of reference valves; and
open comparison valves not connected with the reference gas separation membrane among the plurality of comparison valves.

5. The apparatus of claim 1, wherein the at least one instruction, when executed by the processor communicating with the memory, is configured to cause the apparatus to determine that the plurality of gas separation membranes are not defective, based on a difference between the first rate of change of the first sensing data and the second rate of change of the second sensing data being less than a threshold value.

6. The apparatus of claim 5, wherein the at least one instruction, when executed by the processor communicating with the memory, is configured to cause the apparatus to determine that a disturbance occurs, based on the difference between the first rate of change and the second rate of change being greater than or equal to the threshold value and a peak being detected from the first rate of change or the second rate of change.

7. The apparatus of claim 5, wherein the at least one instruction, when executed by the processor communicating with the memory, is configured to cause the apparatus to determine that the reference gas separation membrane is defective, based on the difference between the first rate of change and the second rate of change being greater than or equal to the threshold value and the first rate of change being greater than the second rate of change.

8. The apparatus of claim 5, wherein the at least one instruction, when executed by the processor communicating with the memory, is configured to cause the apparatus to reassign the reference gas separation membrane to another of the plurality of gas separation membranes to serve as the reference gas separation membrane, based on the difference between the first rate of change and the second rate of change being greater than or equal to the threshold value and the second rate of change being greater than the first rate of change.

9. The apparatus of claim 1, wherein the at least one instruction, when executed by the processor communicating with the memory, is configured to cause the apparatus to:
determine, based on the first sensing data, a first concentration of the target gas, wherein at least a portion of the target gas is in the reference exhaust gas;
determine, based on the second sensing data, a second concentration of the target gas, wherein at least a portion of the target gas is in the total exhaust gas; and
determine, based on a rate of change of the first concentration and a rate of change of the second concentration, whether the reference gas separation membrane is defective.

10. The apparatus of claim 1, wherein the at least one instruction, when executed by the processor communicating with the memory, is configured to cause the apparatus to:
obtain, via a third sensor of the gas system, third sensing data representing a state of the gas mixture,
obtain, based on the first sensing data and the third sensing data, a first performance indicator,
obtain, based on the second sensing data and the third sensing data, a second performance indicator, and
determine, based on a rate of change associated with the first performance indicator and a rate of change associated with the second performance indicator, whether the reference gas separation membrane is defective.

11. The apparatus of claim 10, wherein the at least one instruction, when executed by the processor communicating with the memory, is configured to cause the apparatus to determine the first performance indicator and the second performance indicator, further based on at least one of a recovery rate, a purity, a permeance, or a selectivity associated with the target gas.

12. The apparatus of claim 1, wherein the at least one instruction, when executed by the processor communicating with the memory, is configured to cause the apparatus to indicate, via a management terminal of the gas system and based on the signal, whether the reference gas separation membrane is defective.

13. A method performed by an apparatus of a gas system, the method comprising:
determining a first rate of change associated with first sensing data corresponding to a reference exhaust gas discharged from a reference gas separation membrane, wherein the reference gas separation membrane is selected from a plurality of gas separation membranes;
determining a second rate of change associated with second sensing data corresponding to a total exhaust gas discharged from the plurality of gas separation membranes; and
outputting, based on the first rate of change and the second rate of change, a signal indicating whether at least one of the plurality of gas separation membranes is defective.

14. The method of claim 13, wherein the outputting of the signal indicating whether at least one of the plurality of gas separation membranes is defective comprises determining, based on that a difference between the first rate of change and the second rate of change being less than a threshold value, that the plurality of gas separation membranes are not defective.

15. The method of claim 14, wherein the outputting of the signal indicating whether at least one of the plurality of gas separation membranes is defective comprises determining, based on the difference between the first rate of change and the second rate of change being greater than or equal to the threshold value and a peak being detected from the first rate of change or the second rate of change, that a disturbance occurs.

16. The method of claim 14, wherein the outputting of the signal indicating whether at least one of the plurality of gas separation membranes is defective comprises determining, based on the difference between the first rate of change and the second rate of change being greater than or equal to the threshold value and the first rate of change being greater than the second rate of change, that the reference gas separation membrane is defective.

17. The method of claim 14, further comprising:
reassigning the reference gas separation membrane to another of the plurality of gas separation membranes to serve as the reference gas separation membrane, based on the difference being greater than or equal to the threshold value and the second rate of change being greater than the first rate of change.

18. The method of claim 13, wherein the outputting the signal indicating whether at least one of the plurality of gas separation membranes is defective comprises:
determining, based on the first sensing data, a first concentration of a target gas, wherein at least a portion of the target gas is in the reference exhaust gas;
determining, based on the second sensing data, a second concentration of the target gas, wherein at least a portion of the target gas is in the total exhaust gas; and
determining, based on a rate of change of the first concentration and a rate of change of the second concentration, whether the reference gas separation membrane is defective.

19. An apparatus of a gas system, the apparatus comprising:
a processor; and
a memory storing at least one instruction that, when executed by the processor communicating with the memory, is configured to cause the apparatus to:
obtain first sensing data indicating characteristics of a reference exhaust gas discharged from a reference membrane selected from a plurality of membranes of the gas system;
obtain second sensing data indicating characteristics of a total exhaust gas discharged from the plurality of membranes; and
output, based on the first sensing data and the second sensing data, a signal indicating whether a deviation exists between the reference exhaust gas and the total exhaust gas.

20. The apparatus of claim 19, wherein the deviation between the reference exhaust gas and the total exhaust gas is determined based on a difference between a first rate of change associated with the first sensing data and a second rate of change associated with the second sensing data.
